(19) United States
(12) Patent Application Publication
(10) Pub. No.: US 2024/0338433 A1
(43) Pub. Date: Oct. 10, 2024

(54) INFORMATION PROCESSING APPARATUS, INFORMATION PROCESSING METHOD, AND COMPUTER PROGRAM

(71) Applicant: FeliCa Networks, Inc., Tokyo (JP)

(72) Inventors: Akihiro NONAKA, Tokyo (JP); Shinichi KATO, Tokyo (JP); Yuki MATSUZAKI, Ibaraki (JP)

(73) Assignee: FeliCa Networks, Inc., Tokyo (JP)

(21) Appl. No.: 18/293,377

(22) PCT Filed: Feb. 1, 2022
(86) PCT No.: PCT/JP2022/003807

§ 371 Date: Jan. 30, 2024

(30) Foreign Application Priority Data
Aug. 6, 2021 (JP) 2021-129455

(51) Int. Cl. G06F 21/44; G06F 9/54

(52) U.S. Cl. CPC G06F 21/44; G06F 9/542

(57) ABSTRACT

There is provided an information processing apparatus having a secure element mounted therein. The information processing apparatus in which a device that performs a transaction with an external device is mounted includes: a sensing unit that senses that a transaction has occurred between the device and the external device; an acquisition unit that acquires data from the device, in response to the sensing unit sensing the occurrence of the transaction; a determination unit that analyzes the data acquired by the acquisition unit, and determines applications as notification targets; a verification unit that verifies validity of the applications as the notification targets; and a notification unit that notifies a relevant application whose validity has been confirmed among the notification targets, of the data acquired by the acquisition unit.

### TECHNICAL FIELD

The technology disclosed in the present specification (hereinafter referred to as “the present disclosure”) relates to an information processing apparatus in which a device that performs a transaction with an external device is mounted, an information processing method, and a computer program.

### BACKGROUND ART

Services using a secure element (SE) such as an integrated circuit (IC) chip, a radio frequency identification (RFID) tag, or an IC card are widely used these days. A secure element is a device protected by tamper-resistant hardware, and can perform secure noncontact communication with a reader/writer, using mutual authentication and encryption. Note that, for noncontact communication, a communication method compliant with a short-distance wireless communication standard such as Near Field Communication (NFC) can be used, but detailed explanation thereof is not made in the present specification.

Recently, information terminals such as smartphones equipped with secure elements have been increasing. When an information terminal of this kind is held over a reader/writer, a transaction (such as reading and writing of data from and into a memory in a secure element) is performed between the secure element in the information terminal and the reader/writer. Thus, it is possible to achieve service functions using the secure element, such as a passenger ticket function for public transportation, an electronic money or payment function, a credit card function, a ticket function at an entertainment facility such as a movie theater and a theater, and a personal authentication function (these functions will be hereinafter also referred to simply as “service functions”).

In the information terminal, an application program (hereinafter also referred to as an “SP application”) delivered from a provider (a service provider: SP) that is a provider of each service function is installed, and the SP application is started, so that a procedure with the service provider regarding the corresponding service function (such as charging of electronic money) and an operation regarding a service function (such as display of the usage history and the balance) can be performed. On the other hand, a transaction between the secure element in the information terminal and the reader/writer is caused by a manual operation in which the user holds the information terminal over the reader/writer, for example, and, at that time, there is no need to start any SP application, and any notice is not sent to any SP application. For this reason, for an SP application to display the balance or the like, the SP application needs to grasp information about the transactions performed between the secure element and the reader/writer.

For example, there is a suggested information processing apparatus that stores information regarding a transaction in a second storage unit in a secure element, and analyzes the position and the peripheral situation of the apparatus, the user, an operation of the apparatus, an action of the user, and the like at a time when a transaction is performed on the basis of the information read from the second storage unit by a data acquisition unit on the side of the information processing apparatus (see Patent Document 1). However, it is considered that the transaction information analysis process to be performed in the data acquisition unit is conducted by middleware, and any SP application in this information processing apparatus cannot grasp information about the transactions performed between the secure element and the reader/writer.

### CITATION LIST

### Patent Document

Patent Document 1: WO2019/123851

### SUMMARY OF THE INVENTION

### Problems to be Solved by the Invention

An object of the present disclosure is to provide an information processing apparatus, an information processing method, and a computer program for processing information related to a transaction performed between a device in the main unit and an external device.

### Solutions to Problems

The present disclosure is made in view of the above problem, and a first aspect thereof is an information processing apparatus in which a device that performs a transaction with an external device is mounted,
the information processing apparatus including:
a sensing unit that senses that a transaction has occurred between the device and the external device;
an acquisition unit that acquires data from the device, in response to the sensing unit sensing the occurrence of the transaction;
a determination unit that analyzes the data acquired by the acquisition unit, and determines applications as notification targets;
a verification unit that verifies validity of the applications as the notification targets; and
a notification unit that notifies a relevant application whose validity has been confirmed among the notification targets, of the data acquired by the acquisition unit.

The acquisition unit acquires processing target data of the transaction and data related to processing of the transaction. Further, the determination unit identifies a service ID related to the transaction on the basis of the data acquired by the acquisition unit, and determines an application as a notification target on the basis of the service ID.

The verification unit verifies validity of an application, on the basis of verification information about the application, the verification information being acquired from a server, and information about the application, the information being acquired from an operating system. The verification information includes a package name and a signature value of the application.

The notification unit performs notification to the relevant application, on the basis of information acquired from a server with respect to each application. The information acquired from the server with respect to each application includes at least one of a priority level of notification, a deadline for notification, or an action to be taken when the deadline for notification has passed.

Further, a second aspect of the present disclosure is an information processing method implemented in an apparatus in which a device that performs a transaction with an external device is mounted,
the information processing method including:
a sensing step of sensing that a transaction has occurred between the device and the external device;
an acquisition step of acquiring data from the device, in response to the sensing of the occurrence of the transaction in the sensing step;
a determination step of analyzing the data acquired in the acquisition step, and determining applications as notification targets;
a verification step of verifying validity of the applications as the notification targets; and
a notification step of notifying a relevant application whose validity has been confirmed among the notification targets, of the data acquired in the acquisition step.

Further, a third aspect of the present disclosure is a computer program written in a computer-readable format for an information processing apparatus in which a device that performs a transaction with an external device is mounted,
the computer program causing the information processing apparatus to function as:
a sensing unit that senses that a transaction has occurred between the device and the external device;
an acquisition unit that acquires data from the device, in response to the sensing unit sensing the occurrence of the transaction;
a determination unit that analyzes the data acquired by the acquisition unit, and determines applications as notification targets;
a verification unit that verifies validity of the applications as the notification targets; and
a notification unit that notifies a relevant application whose validity has been confirmed among the notification targets, of the data acquired by the acquisition unit.

The computer program according to the third aspect of the present disclosure is formed by defining a computer program written in a computer-readable format in such a manner as to perform predetermined processing in a computer. In other words, by installing the computer program according to the third aspect of the present disclosure into a computer, a cooperative action is exerted in the computer, and effects similar to those of the information processing apparatus according to the first aspect of the present disclosure can be achieved.

Further, a fourth aspect of the present disclosure is an information processing apparatus in which a device that performs a transaction with an external device is mounted, and an application that provides a service related to the transaction is installed,
the information processing apparatus including:
a notification unit that notifies the application of processing target data of the transaction; and
a presentation unit that presents information related to the processing target data received by the application.

Further, a fifth aspect of the present disclosure is an information processing method implemented by an application in an apparatus in which a device that performs a transaction with an external device is mounted, and the application that provides a service related to the transaction is installed,
the information processing method including:
a receiving step of receiving processing target data of the transaction; and
a presentation step of presenting information related to the received processing target data.

Furthermore, a sixth aspect of the present disclosure is a computer program written in a computer-readable format for an information processing apparatus in which a device that performs a transaction with an external device is mounted, and an application that provides a service related to the transaction is installed,
the computer program causing the information processing apparatus to function as:
a receiving unit that receives processing target data of the transaction; and
a presentation unit that presents information related to the received processing target data.

### Effects of the Invention

According to the present disclosure, it is possible to provide an information processing apparatus, an information processing method, and a computer program for notifying a relevant application of information related to a transaction performed between a device in the main unit and an external device.

Note that the effects described in the present specification are merely examples, and the effects to be brought by the present disclosure are not limited to them. Furthermore, the present disclosure may further provide additional effects in addition to the effects described above.

Still other objects, features, and advantages of the present disclosure will become apparent from a more detailed description based on embodiments as described later and the accompanying drawings.

### BRIEF DESCRIPTION OF DRAWINGS

FIG. 1 is a diagram illustrating an example hardware configuration of an information processing apparatus 100.

FIG. 2 is a diagram illustrating the internal configuration of a secure element unit 114.

FIG. 3 is a diagram illustrating a data structure that stores transaction processing target data in a memory 204 in the secure element unit 114.

FIG. 4 is a diagram illustrating an example configuration of data related to transaction processes.

FIG. 5 is a diagram illustrating the stack structure of the software that is run in the information processing apparatus 100.

FIG. 6 is a diagram illustrating an example operation between software layers when an SP application is notified of transaction information.

FIG. 7 is a flowchart showing the processing procedures for notifying an SP application of information about a transaction performed between the secure element unit 114 and a reader/writer 120.

FIG. 8 is a diagram illustrating a schematic example of the operation to be performed between software layers when validity of SP applications is verified.

FIG. 9 is a diagram illustrating an example of the process sequence between software modules, the process sequence being designed for verifying validity of SP applications determined to be transaction notification targets.

FIG. 10 is a diagram illustrating the data structure of SP application attribute information acquired from a SIM server.

FIG. 11 is a diagram illustrating the data structure of a header portion that specifies uniqueness of a transaction.

FIG. 12 is a diagram illustrating the data structure of a payload of information about a transaction related to payment.

FIG. 13 is a diagram illustrating the data structure of a payload of information about a transaction related to an action other than payment.

FIG. 14 is a diagram illustrating an example in which a screen is updated in response to the occurrence of a transaction.

FIG. 15 is a diagram illustrating another example in which a screen is updated in response to the occurrence of a transaction.

### MODE FOR CARRYING OUT THE INVENTION

In the description below, the present disclosure will be explained in the following order, with reference to the drawings.
A. Apparatus Configuration
B. Functional Configuration of a Secure Element
C. Software Configuration
D. Transaction Notification Function
E. SP Application Validity Verification Process
F. Effects

### A. Apparatus Configuration

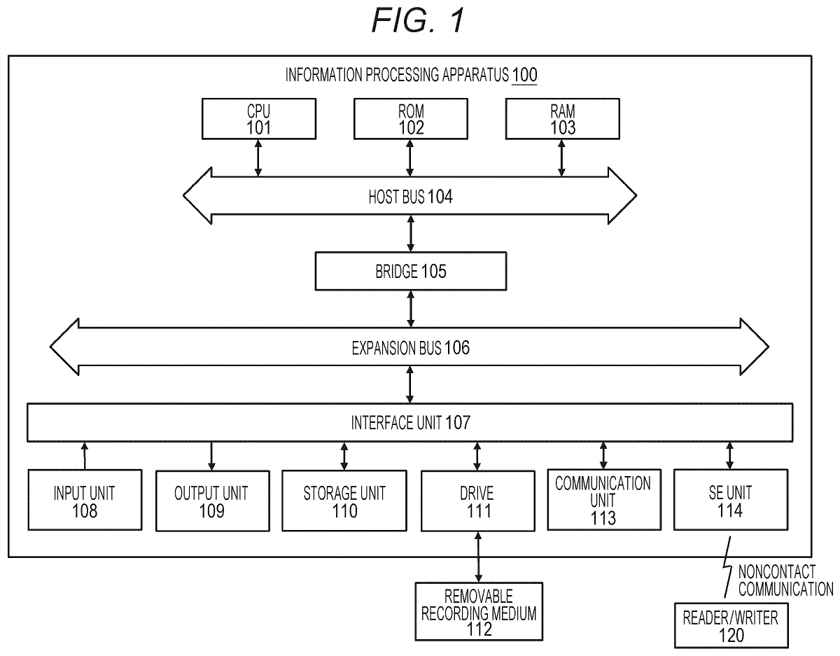

FIG. 1 schematically illustrates an example hardware configuration of an information processing apparatus 100 to which the present disclosure is applied. The information processing apparatus 100 is assumed to be a multifunctional information terminal such as a smartphone or a tablet equipped with a secure element, for example, but some other type of information device such as a personal computer (PC) may be used.

The information processing apparatus 100 illustrated in the drawing includes a central processing unit (CPU) 101, a read only memory (ROM) 102, a random access memory (RAM) 103, a host bus 104, a bridge 105, an expansion bus 106, an interface unit 107, an input unit 108, an output unit 109, a storage unit 110, a drive 111, a communication unit 113, and a secure element (SE) unit 114.

The CPU 101 functions as an arithmetic processing device and a control device, and controls all operations of the information processing apparatus 100 according to various programs. The ROM 102 stores, in a nonvolatile manner, programs (a basic input-output system and the like), operation parameters, and the like to be used by the CPU 101. The RAM 103 is used to load a program to be used in execution by the CPU 101, and temporarily store parameters such as working data that appropriately change during program execution. Examples of the programs to be loaded into the RAM 103 and executed by the CPU 101 include various application programs, an operating system (OS), and middleware (MW), for example.

The CPU 101, the ROM 102, and the RAM 103 are interconnected by the host bus 104 formed with a CPU bus or the like. The CPU 101 then operates in conjunction with the ROM 102 and the RAM 103, to execute various application programs under an execution environment provided by the OS, and provide various functions and services. In a case where the information processing apparatus 100 is a smartphone or a tablet, the OS is Android of Google Inc., for example. Further, the application programs include an SP application distributed from an SP provider related to a secure element service function.

The host bus 104 is connected to the expansion bus 106 via the bridge 105. However, the information processing apparatus 100 does not necessarily have a configuration in which circuit components are separated by the host bus 104, the bridge 105, and the expansion bus 106, but almost all circuit components may be interconnected by a single bus (not illustrated in the drawing) in the configuration.

The interface unit 107 connects peripheral devices such as the input unit 108, the output unit 109, the storage unit 110, the drive 111, the communication unit 113, and the secure element (SE) unit 114 according to the standard of the expansion bus 106. However, in order for the information processing apparatus 100 to operate as an information terminal such as a smartphone or a tablet, not all the peripheral devices illustrated in FIG. 1 are necessary, and the information processing apparatus 100 may further include a peripheral device not illustrated in the drawing. Further, the peripheral devices may be included in the main unit of the information processing apparatus 100, or some of the peripheral devices may be externally connected to the main unit of the information processing apparatus 100.

The input unit 108 is formed with an input control circuit or the like that generates an input signal on the basis of an input from a user, and outputs the input signal to the CPU 101. In a case where the information processing apparatus 100 is an information terminal such as a smartphone or a tablet, the input unit 108 is a touch-screen or a microphone, for example, but may further include another mechanical operator such as a button. Further, in a case where the information processing apparatus 100 is an information terminal such as a smartphone or a tablet, a camera mounted in the information terminal may be included in the input unit 108.

The output unit 109 includes a display device such as a liquid crystal display (LCD) device, an organic electro-luminescence (EL) display device, a light emitting diode (LED), or the like, for example, and displays various kinds of data such as video data in the form of an image or text, or displays a graphical user interface (GUI) screen. The output unit 109 also includes an audio output device such as a speaker, headphones, or the like, and converts audio data or the like into voice to be output.

The storage unit 110 stores files such as programs (applications, an OS, middleware, and the like) to be executed by the CPU 101 and various kinds of data. The storage unit 110 includes a mass storage device such as a solid state drive (SSD), for example, but may include an external storage device such as a hard disk drive (HDD).

A removable storage medium 112 is a cartridge-type storage medium such as a micro-SD card, for example. The drive 111 performs read and write operations on the removable storage medium 113 mounted therein. The drive 111 outputs data (such as a still image or a moving image, for example) read from the removable recording medium 112 to the RAM 103, and writes data in the RAM 103 into the removable recording medium 112.

The communication unit 113 is a device that performs wireless communication such as a cellular communication network of 4G, 5G, or the like, Wi-Fi (registered trademark), or Bluetooth (registered trademark). The communication unit 113 also includes a terminal such as a high-definition multimedia interface (HDMI, a registered trademark), and may further include a function of performing HDMI (registered trademark) communication with a display or the like.

The secure element (SE) unit 114 is a device that is called an IC chip or an RFID tag, and is protected by tamper-resistant hardware. Tamper-resistance means that internal analysis (reverse engineering) and modifications are extremely difficult, and is achieved with a logical means such as obfuscation to hinder analysis, or a physical means such as a circuit that is destroyed when its protective layer is removed. The secure element unit 114 is also capable of secure noncontact communication with a reader/writer 120, using mutual authentication and encryption. Noncontact communication is performed with electromagnetic waves emitted from the reader/writer 120. Communication is symmetric communication not using any subcarrier, and is performed at a speed of 212 kbps/424 kbps, using a frequency band of 13.56 MHZ.

### B. Functional Configuration of a Secure Element

The secure element unit 114 can manage multipurpose data in a single secure element module. Individual access rights can be set for the respective pieces of data in the memory in the secure element unit 114, so that secure interoperability between applications can be achieved.

When the information processing apparatus 100 is held over the reader/writer 120, and the secure element unit 114 enters the range a carrier wave from the reader/writer 120 reaches, a transaction is performed between the secure element unit 114 and the reader/writer 120 not in synchronization with the operation of the main unit of the information processing apparatus 100 (alternatively, there is no need to start any application, and any notice is not issued). The transaction here is a process related to various service functions such as a credit card function, a ticket function, a personal authentication function, a passenger ticket function, or an electronic money or payment function. Taking advantage of the tamper-resistance of the secure element unit 114, transactions can be safely performed.

In the secure element unit 114, transaction processing target data (electronic money or the like) is stored in a secure memory region (described later) that can prevent data falsification, data leakage, and unauthorized use of data by eliminating direct access from outside. Further, in this embodiment, data related to transaction processes is also stored in the secure element unit 114. The data related to transaction processes includes information that can recognize “processing for a service ID XX has occurred”, and the like.

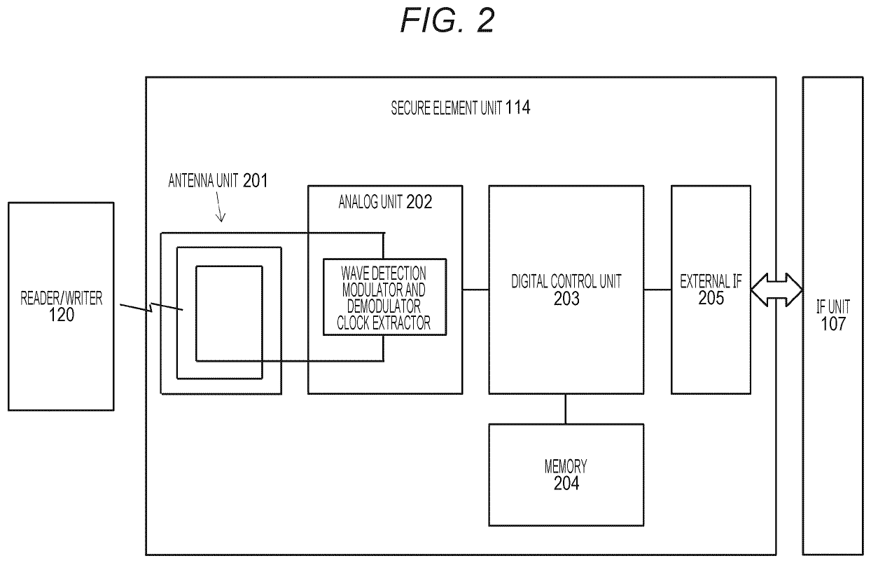

FIG. 2 schematically illustrates the internal configuration of the secure element unit 114. The secure element unit 114 includes an antenna unit 201, an analog unit 202 connected to the antenna unit 201, a digital control unit 203, a memory 204, and an external interface (external IF) 205, and is mounted in the information processing apparatus 100. The secure element unit 114 may be formed with a one-chip semiconductor integrated circuit, or may be formed with a two-chip semiconductor integrated circuit that has the RF analog front end and the logic circuit unit separated from each other.

The antenna unit 201 and the analog unit 202 constitute a noncontact interface between the secure element unit 114 and the reader/writer 120. The antenna unit 201 transmits and receives noncontact data to and from the reader/writer 120. The analog unit 202 performs processing of analog signals transmitted and received to and from the antenna unit 201, such as detection, modulation/demodulation, and clock extraction. The reader/writer 120 transmits a modulated carrier wave including a data read request or a data write request, and an unmodulated reply carrier wave from the secure element unit 114. The analog unit 202 reflectively transmits, from antenna unit 201, a carrier wave in which the reply data is superimposed on the unmodulated carrier wave. For example, an NFC communication scheme is used for noncontact communication with the reader/writer 120. Secure noncontact communication is also possible with the reader/writer 120, using mutual authentication and encryption.

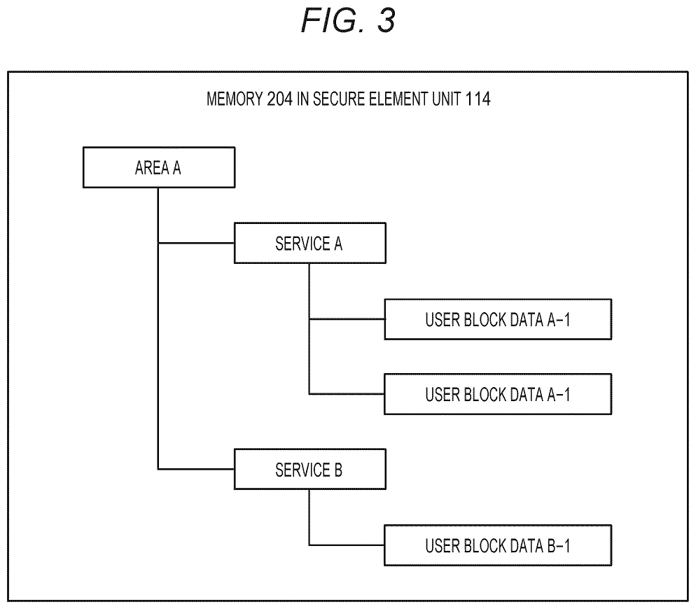

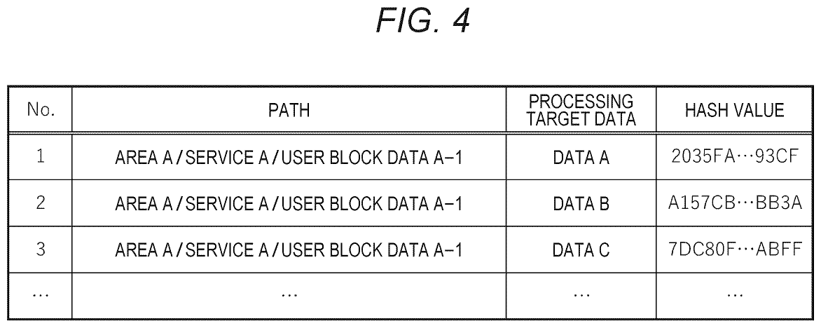

The digital control unit 203 comprehensively controls processes of transmitting and receiving to and from the reader/writer 120, and other operations in the secure element unit 114. The digital control unit 203 also has an addressable memory 204 locally connected thereto. The memory 204 is formed with a nonvolatile storage device such as an electrically erasable programmable read-only memory (EEPROM), and is used to store data related to various service functions (which are transaction processing targets) such as a passenger ticket function, an electronic money or payment function, a credit card function, a ticket function, and a personal authentication function. The digital control unit 203 constructs a hierarchical structure (see FIG. 3) in a memory space in the memory 204, and stores data to be processed in transactions. Further, in this embodiment, data related to transaction processes (see FIG. 4) is also stored in the memory 204. Furthermore, program codes to be executed by the digital control unit 203 may be written into the memory 204, or the memory 204 may be used to store working data during program execution.

The external interface 205 is a functional module for the digital control unit 203 to establish wired connection with the main unit of the information processing apparatus 100, according to an interface protocol for connection with the interface unit 107 on the side of the information processing apparatus 100. The data written in the memory 204 can be transferred to the main unit of the information processing apparatus 100 (the CPU 101 or the RAM 103) via the external interface 205. Further, the side of the information processing apparatus 100 (a software program to be executed by the CPU 101, for example) can perform operations such as reading data from and writing data into the memory 204 via the external interface 205 and the digital control unit 203.

FIG. 3 schematically illustrates the data structure in the memory region that is constructed in the memory 204 in the secure element unit 114 and stores transaction processing target data. This memory region is a memory region that can be accessed under the control of the digital control unit 203, and is a secure memory region in which data falsification, data leakage, unauthorized use of data, and the like can be prevented by exclusion of direct access from outside. In the memory region illustrated in the drawing, data is managed by a hierarchical structure that includes an “area”, “services”, and “user block data”.

An “area” corresponds to a “directory” or a “folder”, and a hierarchically lower area can be further created below the area. Areas are formed on a service provider basis, for example, but, in a case where the secure element unit 114 is compatible with a plurality of service providers, a plurality of areas can be formed in the memory 204. Of course, a plurality of areas may be formed for one service provider, or one area may be shared by a plurality of service providers.

A “service” is a concept for managing authority to access data, the encryption method, and the like. Specifically, data stored under a service is controlled on the basis of the access authority, the encryption method, or the like defined for the service. For example, it is assumed that a service A in FIG. 3 stores unencrypted data, and a service B stores data encrypted according to a predetermined encryption method. In this case, user block data A-1 and user block data A-2, which are data of relatively low importance, can be stored under the service A, without being encrypted. On the other hand, user block data B-1, which is data of relatively high importance, can be encrypted by the encryption method defined by the service B, and be stored under the service B. A plurality of services can be present in one hierarchical structure.

The “user block data” is a storage region for storing data to be used in processing by the secure element unit 114 (which is the processing target data), or is the data, and a plurality of pieces of user block data may be present in one hierarchical structure.

In this embodiment, data related to transaction processes (see FIG. 4) is also stored in the memory 204. FIG. 4 illustrates an example configuration of the data related to transaction processes.

In the example illustrated in FIG. 4, the data related to each transaction process includes the path for the processing target data in the memory region (see FIG. 3), the processing target data, the hash value of the processing target data, and the like.

When a transaction with the reader/writer 120 is performed, the digital control unit 203 stores the processing target data and the path for the processing target data in the memory region (see FIG. 3) as the data related to the processing of the transaction. The digital control unit 203 further calculates the hash value of the processing target data, and also stores the hash value as the data related to the processing of the transaction.

Note that the digital control unit 203 may appropriately add data other than the data illustrated in FIG. 4. For example, the digital control unit 203 may add data related to an attribute (the contents, the type, the degree of importance, or the like, for example) of the processing target data. The digital control unit 203 may also replace the data illustrated in FIG. 4 with some other data corresponding to that data. For example, the digital control unit 203 may replace the path for the processing target data with any data that can specify the processing target data. Further, the digital control unit 203 may calculate a hash value including not only the processing target data but also data (the path for the processing target data, for example) other than the processing target data. Thus, the main unit side of the information processing apparatus 100 can verify integrity of data including not only the processing target data but also data other than the processing target data.

### C. Software Configuration

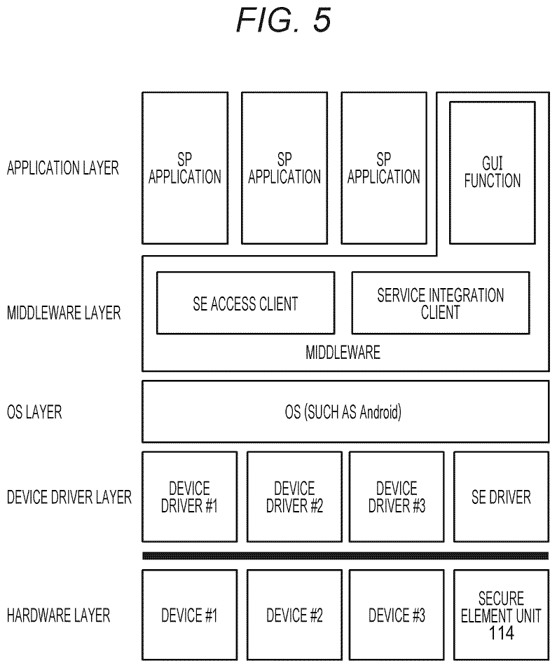

FIG. 5 schematically illustrates the stack structure of the software that is run in the information processing apparatus 100. The software stack includes a device driver layer, an OS layer, a middleware layer, and an application layer in this order from the bottom.

### Device Driver Layer:

The device driver layer, which is the lowermost layer, includes a set of device drivers that individually control the respective pieces of hardware included in the information processing apparatus 100. In the “hardware” herein, a device driver for drive control is provided for each of the individual hardware components forming the input unit 108, the output unit 109, the storage unit 110, the drive 111, the communication unit 113, and the like. In this embodiment, a device driver (which is shown as “SE driver” In FIG. 5) for the secure element unit 114 is also provided. Here, the device drivers other than the SE driver are general drivers and are not related directly to the present disclosure, and therefore, explanation thereof is kept to the minimum necessary explanation in the present specification.

A device driver has a function of notifying the OS of an event when the event occurs in the corresponding device. The notification of the event is made by processing such as generation of an interrupt or polling, for example. In the case of the SE driver, for example, it is possible to detect the occurrence of an event by receiving an interrupt signal from the external interface unit 205 in the secure element unit 114 or polling a status register in the external interface unit 205. Specifically, using a function of a “noncontact communication applet”, the SE driver detects an event in which noncontact communication between the secure element unit 114 and the reader/writer 120 has started or ended (or an event in which the secure element unit 114 turns on and off a carrier wave from the reader/writer 120), and then notifies the OS of the event.

A device driver also controls hardware operations unique to the device, such as operations to input and output data to and from the corresponding device, and an operation to drive the device. For example, the SE driver has a function of performing transactions such as reading and writing data from and into the memory 204 through the external interface unit 205 in the secure element unit 114, in response to an access request to the secure element unit 114 from a higher layer (specifically, an access request from an application (SP application) via middleware). This function is formed with a “transaction applet”. The OS and the middleware can access the transaction applet via an open mobile API (OMAPI). The transaction applet stores transaction processing target data. The transaction processing target data is handled on an application protocol data unit (APDU) basis.

In the memory 204 in the secure element unit 114, the structure of the memory space for storing the transaction processing target data is as described above with reference to FIG. 3. In this embodiment, a mechanism capable of recognizing the contents of a process (for example, “a process with service ID XX has occurred” or the like) at a time of writing from the reader/writer 120 into the memory 204 is introduced.

### OS Layer:

The OS provides an application with an execution environment including functions that are used and shared by many applications, basic control functions of hardware, and the like. In a case where the information processing apparatus 100 is an information terminal such as a smartphone or a tablet, for example, Android of Google Inc. or the like corresponds to the OS. In a case where the OS is Android, information related to the entire system such as an event notification from a device driver is transmitted to all applications through a mechanism called “BroadcastIntent”. Note that Intent is a message object that is exchanged between one or more activities or services included in an application operating on Android.

### Middleware Layer:

The middleware is located between the OS and the applications, and provides functions that are used and shared by various kinds of software. For example, specific or individual functions with limited fields and use applications are provided not by the OS but by the middleware. Since not all models of information terminals such as smartphones and tablets are equipped with a secure element, the functions related to use of the secure element unit 114 are provided as the middleware in this embodiment. Also, a GUI function and the like are provided as the middleware. However, since the functions of the middleware that are not related to the secure element unit 114 are not related directly to the present disclosure, explanation thereof is kept to the minimum necessary explanation in the present specification.

In this embodiment, an “SE access client” and a “service integration client” are included among the functions that are related to use of the secure element unit 114 and are provided by the middleware. The “SE access client” is a function of performing an operation to access the secure element unit 114. Meanwhile, the “service integration client” is a function of managing information regarding the service being used in the secure element unit 114, in cooperation with a server (hereinafter referred to as the “service integration server”) (not shown in FIG. 5).

### Application Layer:

The application layer, which is the uppermost layer, includes a set of pieces of application software to be used in accordance with the purpose of each operation. Each piece of the application software uses a function provided by the OS or the middleware, to serve the purpose of each operation. For example, it is assumed that application software such as a telephone, electronic mail, a camera, and calendar/schedule management is installed in the information processing apparatus 100. These general pieces of application software are not related directly to the present disclosure, and therefore, explanation thereof is kept to the minimum necessary explanation in the present specification.

Further, in this embodiment, it is assumed that one or a plurality of SP applications that provide service functions (a passenger ticket function, an electronic money or payment function, a credit card function, a ticket function, a personal authentication function, and the like) using the secure element unit 114 is installed in the information processing apparatus 100. The information processing apparatus 100 having such SP applications installed therein can operate as an IC card that provides the corresponding service functions. The service integration client manages, for each SP application installed in the information processing apparatus 100, service IDs for identifying the services to be used, and card IDs (CIDs) for identifying the cards that can be referred to from the SP applications.

In a case where an SP application actively accesses the information in the secure element unit 114, the SP application needs to exclusively have the right to use the secure element unit 114. Normally, an SP application performs a use application procedure on the service integration client, and the service integration client makes an inquiry to the service integration server about validity (identity) confirmation of the SP application or an operation on the secure element permitted for the SP application. The SP application then exclusively holds the right to use the secure element unit 114. Therefore, when the SP application attempts to access the secure element unit 114, the processing time, the network load, and the server load that accompany the exclusive right to use the secure element unit 114 are necessary.

The SP application that has obtained and now holds the exclusive right to use the secure element unit 114 can access the secure element unit 114 through the SE access client that is a function of the middleware, or perform a data read or write operation on the memory 204 in the secure element unit 114.

Note that, to ensure the security of the secure element unit 114, it is not preferable that an SP application can access the secure element unit 114 without limitation. Therefore, the SE access client performs access restriction such as verifying an SP application that requests access to the secure element unit 114 and prohibiting simultaneous access to the secure element unit 114 by a plurality of SP applications.

### D. Transaction Notification Function

The information processing apparatus 100 having SP applications installed therein can operate as an IC card that provides the corresponding service functions. For example, a manual operation in which the user holds the information processing apparatus 100 over the reader/writer 120 causes a transaction between the secure element unit 114 mounted in the information processing apparatus 100 and the reader/writer 120.

Such a transaction does not require a start of any SP application, and occurs without notice to any SP application. For this reason, for an SP application to indicate the balance or the like, the SP application needs to grasp the latest information stored in the memory 204 in the secure element unit 114.

As described above in Section C, the SE access client in the middleware restricts access to the secure element unit 114 (by verifying SP applications, prohibiting simultaneous access by a plurality of SP applications, and the like), to ensure security. Under such access restriction, when each SP application attempts to access the memory 204 in the secure element unit 114 periodically and actively to grasp the latest information, a problem arises in that access contention among a plurality of SP applications is likely to occur.

Also, an SP application cannot immediately sense a change occurring without notice in the information in the memory 204 simply by periodically accessing the memory 204, and therefore, information acquired from the memory 204 by SP applications lacks real-time properties. Further, even if any change has not occurred in the information in the memory 204, the SP applications need to periodically access the memory 204, resulting in performing unnecessary processes. When an SP application accesses the secure element unit 114, the service integration client needs to access the service integration server, to verify the validity of the SP application and acquire a list of the cards that can be referred to from the SP applications. Therefore, there is the processing load on the information processing apparatus 100 to connect to the network, and the server load increases.

In view of this, the present disclosure suggests a method for presenting a function of notifying the necessary SP application of transaction information mainly through the function of the service integration client in the middleware when a transaction occurs between the secure element unit 114 and the reader/writer 120. However, simply adding a notification function might result in notification to an invalid SP application or an irrelevant application, and result in leakage of sensitive payment information. Therefore, in the present disclosure, determination of the SP application requiring notification of information and verification of validity of the SP application are performed at once, and notification of transaction information to the SP application is then performed.

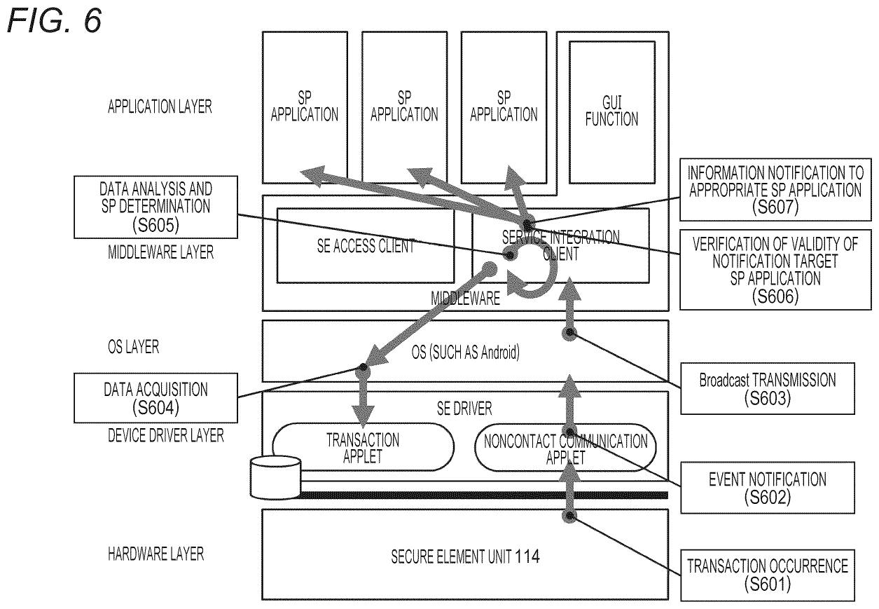

FIG. 6 illustrates an example operation between software layers when an SP application is notified of information about a transaction between the secure element unit 114 and the reader/writer 120.

First, a manual operation in which the user holds the information processing apparatus 100 over the reader/writer 120 causes a transaction between the secure element unit 114 mounted in the information processing apparatus 100 and the reader/writer 120 (S601). Such a transaction occurs without notice in the relevant SP application. In the transaction, a carrier wave is transmitted from the reader/writer 120. The carrier wave includes a modulated carrier wave including a data read request or a data write request from the reader/writer 120, and an unmodulated reply carrier wave from the secure element unit 114. At that point of time, the data of the transaction is stored into the transaction applet.

Having sensed the occurrence of the transaction between the secure element unit 114 and the reader/writer 120, the noncontact communication applet of the SE driver notifies the OS of an event (S602). Having sensed the event, the OS then transmits Broadcast, to notify the higher layer that the state of the system has changed (S603).

Receiving the Broadcast that notifies the event from the OS, the service integration client in the middleware accesses the transaction applet via the OMAPI. The service integration client then acquires the corresponding transaction processing target data (APDU) from the secure element unit 114 through the transaction applet (S604). At that point of time, the service integration client also acquires data related to the transaction process, together with the transaction processing target data.

Next, the service integration client analyzes the acquired data for each service provider (SP), and determines the SP application for which notification of transaction information is necessary (S605). The data related to the transaction process acquired together with the transaction processing target data includes information from which “a process with service ID XX has occurred” or the like can be recognized. Accordingly, the service integration client can identify the service ID related to the transaction by analyzing the data related to the transaction process, and determine the notification target SP applications on the basis of the service ID.

Next, the service integration client verifies the validity of each SP application determined to be a notification target (S606). The service integration client verifies the validity of the SP applications on the basis of verification information acquired beforehand from a server. Specifically, the package names of the SP applications and the signature values of the SP applications are used as the verification information. A service information management (SIM) server manages information including the verification information regarding each SP application. The process of verifying the validity of the notification target SP applications will be described later in detail.

The service integration client then notifies the relevant SP applications, whose validity has been verified, of the transaction information (S607). The transaction information of which the SP applications are notified will be described later in detail.

Note that, in a case where a plurality of SP applications is notified, information notification is performed at predetermined time intervals between the SP applications. This is because there is a possibility that the SP applications will start accessing the secure element unit 114 upon receipt of the notification of the transaction information. Examples of the cause of access include automatic charging due to a decrease in balance after a transaction, and a remaining point read process that accompanies payment.

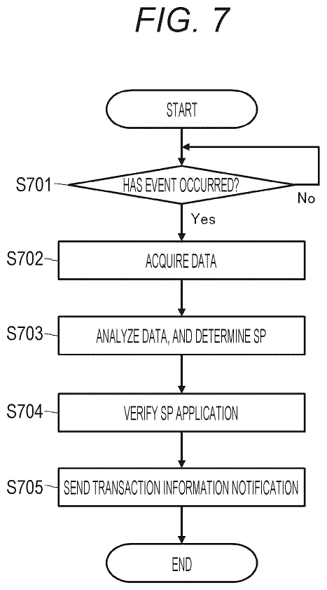

FIG. 7 illustrates, in the form of a flowchart, the processing procedures for notifying an SP application of information about a transaction performed between the secure element unit 114 and the reader/writer 120, the processing procedures being carried out in the information processing apparatus 100. The processing procedures illustrated in the drawing are implemented mainly by the service integration client included in the middleware layer.

The service integration client is notified of an event indicating that a transaction has been performed between the secure element unit 114 and the reader/writer 120 via the OS (Yes in step S701).

In response to the event notification, the service integration client accesses the transaction applet in the SE driver via the OMAPI, and acquires the transaction processing target data and the data related to the transaction process (step S702).

Next, the service integration client analyzes the acquired data for each service provider (SP), and determines the SP applications for which notification of transaction information is necessary (S703). Since the data related to the transaction process includes information from which “a process with service ID XX has occurred” or the like can be recognized, the service integration client can identify the corresponding service IDs by data analysis, and determine the notification target SP applications on the basis of the service IDs.

Next, the service integration client verifies the validity of each SP application determined to be a notification target, on the basis of the verification information about each SP application acquired beforehand from the SIM server (step S704). The process of verifying the validity of the notification target SP applications will be described later in detail.

The service integration client then notifies the relevant SP applications, whose validity has been verified, of the transaction information (step S705). The transaction information of which the SP applications are notified will be described later in detail.

### E. SP Application Validity Verification Process

In this Section E, the SP application validity verification process to be performed when the transaction notification function described above in Section D determines the notification target SP applications is described in detail.

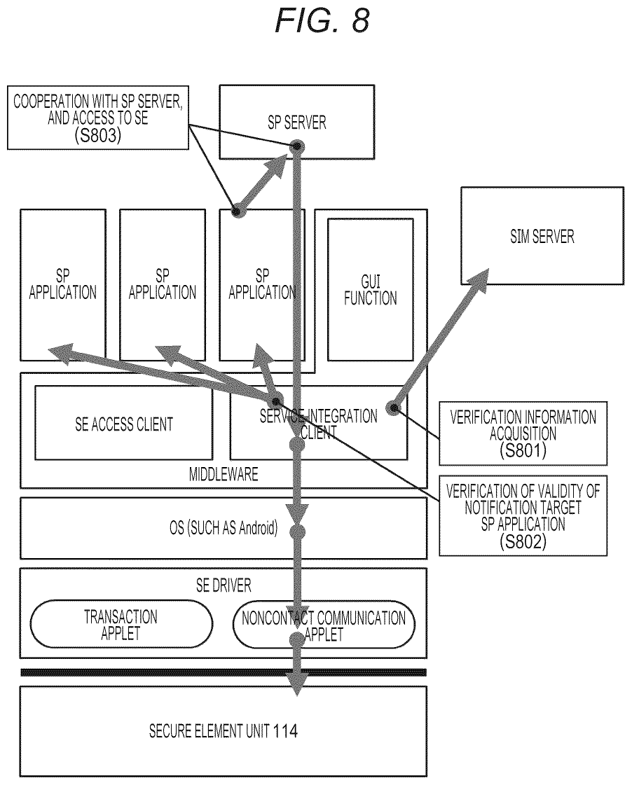

FIG. 8 illustrates a schematic example of the operation to be performed between software layers when validity of the SP applications determined to be the transaction notification targets is verified.

As preprocessing, the service integration client acquires the verification information regarding each SP application installed in the information processing apparatus 100 from the SIM server (S801). The verification information includes information for uniquely identifying the SP applications such as package names, SP application signature values (such as application signer certificate hashes), and the like.

After that, when a transaction occurs between the secure element unit 114 and the reader/writer 120, the service integration client can sense the event through reception of Broadcast from the OS.

The service integration client analyzes the data acquired through the transaction applet for each SP, determines the SP application to be a transaction information notification target, and then verifies validity of each SP application determined to be a notification target, using the verification information acquired beforehand from the SIM server (S802). The service integration client then notifies each SP application, whose validity has been successfully verified, of the transaction information.

The SP applications can promptly present information such as the balance indicator changed by the transaction, using the transaction information sent from the service integration client. Also, the SP applications perform user notification and access to the secure element unit 114, in cooperation with an SP server (S803). Specifically, the SP applications access the secure element unit 114 in cooperation with the SP server, and performs procedures for the service providers regarding the corresponding service functions, such as automatic charging due to a decrease in balance after a transaction, or a process of reading the remaining points after payment.

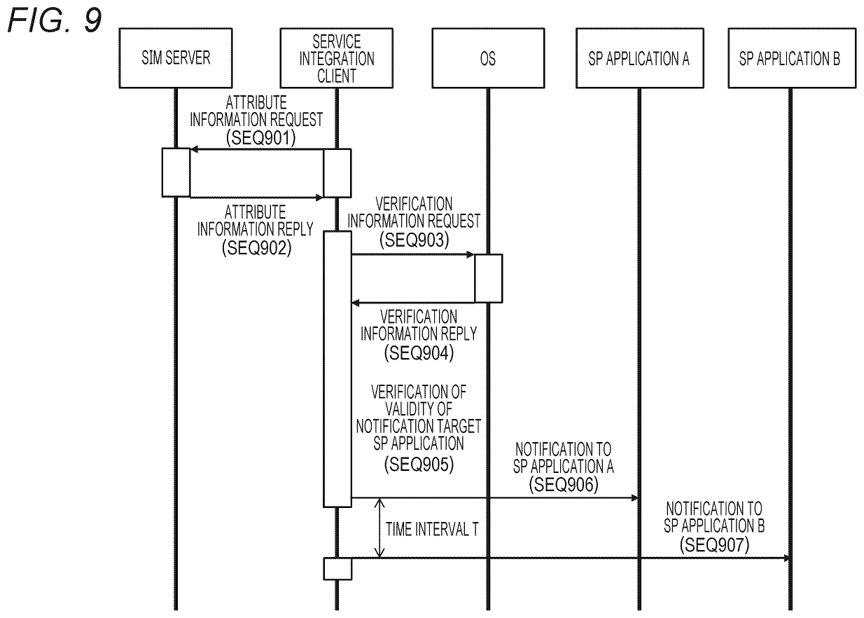

FIG. 9 illustrates an example of the process sequence between software modules, the process sequence being designed for verifying validity of SP applications determined to be transaction notification targets. In

FIG. 9, the transaction notification targets are only the two applications of an SP application A and an SP application B, because of space limitations. Further, for ease of explanation, it is assumed that both the SP application A and the SP application B are to succeed in validity verification.

The service integration client requests the SIM server for attribute information about each SP application installed in the information processing apparatus 100 (SEQ 901). In response to this, the SIM server returns the attribute information about each requested SP application (SEQ 902). The attribute information about the SP applications includes the verification information, and the acquisition of the attribute information from the SIM server serves as the preprocessing for verifying the validity of the SP applications. For example, every time the middleware is started periodically (for example, once every 30 days, once every 100 times, or the like), the service integration client checks update information with the SIM server, and acquires the latest attribute information about each installed SP application in advance.

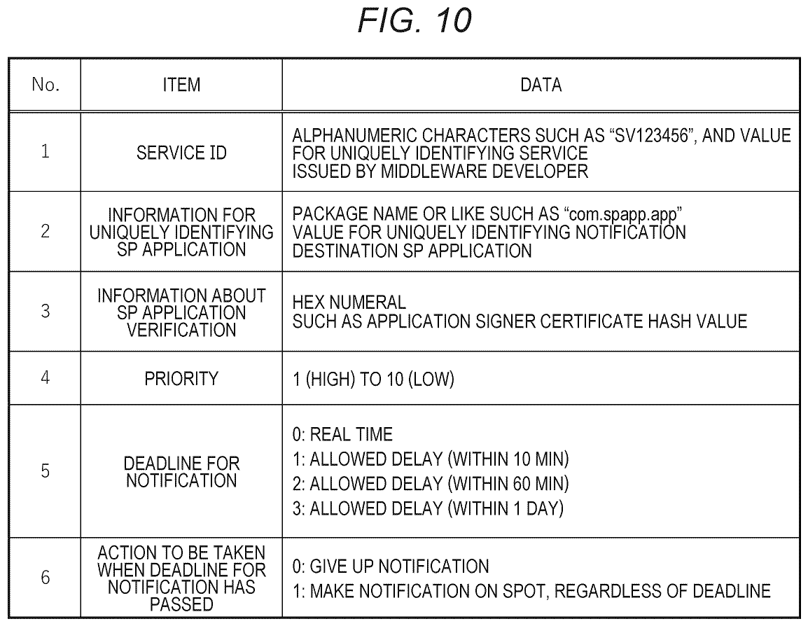

For reference, FIG. 10 illustrates an example of the data structure of SP application attribute information acquired from the SIM server by the service integration client. To be precise, the service integration client acquires, from the SIM server, a list of data as illustrated in FIG. 10 for each SP application. In the description below, the respective pieces of data are explained.

“Service ID” is formed with the value uniquely representing the service to be performed by the SP application. For example, in the case of an SP application that conducts payment, the value uniquely represents a payment service. Normally, the service ID is an alphanumerical value such as “SV123456”, which is issued by the middleware developer (a platformer that provides secure elements).

“Information for uniquely identifying an SP application” is the package name of the SP application such as “com.spapp.app”. “Signature value” is an SP application signer certificate hash in hexadecimal, for example. A signer certificate of the SP application is acquired from the OS, a hash value is calculated, and the hash value is checked against the signature value included in SP application attribute information, so that validity of the SP application can be verified.

“Priority”, “deadline for notification”, and “action to be taken when deadline for notification has passed” are parameters that specify a notification operation in a case where a plurality of SP applications is valid notification targets. “Priority” indicates the level of priority of transaction information notification on a scale of 1 to 10. In a case where a plurality of SP applications is determined to be valid notification targets, transaction information notification is performed in descending order starting from the SP application with the highest level of priority. “Deadline for notification” indicates the amount of time the SP application allows as a delay in notification, on a scale of 0 to 3. “Action to be taken when the deadline for notification has passed” indicates, with a value of 0 or 1, whether to give up the notification or to make the notification when the delay time designated by the “deadline for notification” is exceeded.

Referring back to FIG. 9, the process sequence for verifying validity of SP applications is described.

After that, when a transaction occurs between the secure element unit 114 and the reader/writer 120, the service integration client identifies the notification target SP applications, and performs a process of verifying validity of each of the notification target SP applications (the SP application A and the SP application B in the example illustrated in FIG. 9).

In this validity verification process, the service integration client first identifies the notification target SP applications. After analyzing the data related to the transaction process and identifying the service IDs, the service integration client can check the service IDs against the attribute information (see FIG. 10) about the respective SP applications acquired beforehand in the preprocessing, and identify the SP applications having the same service ID to be the notification targets. In the example of the process sequence illustrated in FIG. 9, the two applications of the SP application A and the SP application B are identified to be the notification targets.

Next, the service integration client requests the verification information about the SP application to be the notification target of each SP (SEQ 903), and, in response to this, the OS returns the verification information about each SP application (SEQ 904). An OS for smartphones, such as Android of Google Inc., grasps the verification information about each SP application through the mutual authentication procedure carried out at the time of application installation. Thus, the service integration client can acquire the verification information about each notification target SP application by making an inquiry to the OS.

Next, the service integration client verifies validity of each notification target SP application (SEQ 905). The service integration client performs verification by checking the verification information included in the attribute information about each notification target SP application against the verification information about the corresponding SP application acquired from the OS, and, when the verification information matches the verification information about the corresponding SP application, the service integration client can determine that the SP application is valid. In the example of the process sequence illustrated in FIG. 9, validity is confirmed for both the SP application A and the SP application B identified to be notification targets.

For example, a smartphone using Android as the OS can install an application from a site other than its official application store. In such a case, the user erroneously recognizes an application created by falsifying the external appearance or the package name like the real one as a valid application, and installs the application into his/her own terminal. As a result, there is a possibility that the information in the secure element unit 114 will be leaked, be illegally used, or be falsified through the application. In this embodiment, on the other hand, validity of an SP application is verified with the verification information obtained by combining the package name of the SP application and the signature value of the SP application. Thus, it is possible to prevent leakage, unauthorized use, falsification, and the like of the information in the secure element unit 114, by eliminating unauthorized SP applications.

The service integration client then notifies the notification target SP applications, whose validity has been confirmed, of the transaction processing target data. In the example of the process sequence illustrated in FIG. 9, validity of both the SP application A and the SP application B is confirmed. After that, a notification process is first performed on the SP application A (SEQ 906), and the notification process is then performed on the SP application B (SEQ 907).

In a case where notification to a plurality of SP applications is performed, the notification is performed in descending order of priority levels included in the attribute information about the respective SP applications. In the example illustrated in FIG. 9, the SP application A has a higher priority level than the SP application B.

Further, after the notification process (SEQ 906) is performed on the SP application A, the notification process (SEQ 907) is performed on the SP application B after a predetermined time interval (T). This is because there is a possibility that both the SP application A and the SP application B, which have received the notification, will start accessing the secure element unit 114 upon receipt of the notification of the transaction information. Examples of the cause of access include automatic charging due to a decrease in balance after a transaction, and a remaining point read process that accompanies payment. If the time interval before and after receipt of the notification is not sufficiently long between the SP applications, there is a possibility that a process such as access to the secure element unit 114 might cause a contention between the SP application A and the SP application B that have received the notification before and after the time interval.

In a case where a contention occurs between the SP applications that receive the notification before and after a time interval, the process for the next SP application is started after the process for the SP application that has received the notification earlier is completed. In this case, a notification delay occurs in the SP application that is the latter in notification order. In a case where a notification deadline having a delay allowed or a notification deadline has passed, the parameters included in the attribute information regarding each SP (see FIG. 10) may be followed.

Next, the data structure of the transaction information of which the SP applications are notified from the service integration client is described. This data structure includes a header portion that specifies uniqueness of a transaction, and a payload corresponding to the type of the transaction.

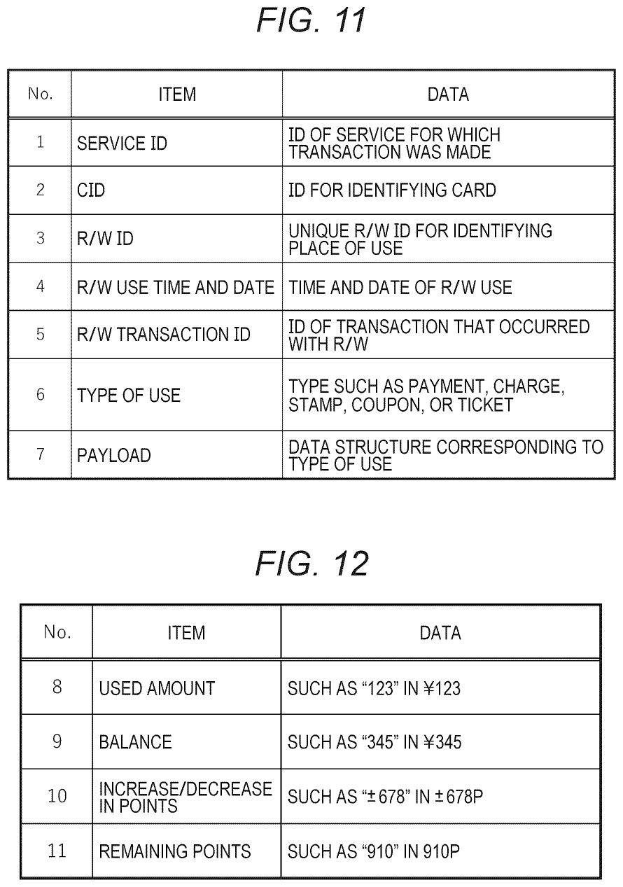

FIG. 11 illustrates the data structure of the header portion that specifies uniqueness of a transaction. The header portion that specifies uniqueness of a transaction is a common data structure that does not depend on the type of use of the transaction (payment or other than payment).

A service ID is identification information for uniquely identifying a service (for example, a service for which payment has been made) processed by a transaction. A CID is identification information for identifying a card. A R/W ID is identification information unique to the reader/writer at the other end of the transaction. The place of use can be identified on the basis of the R/W ID. R/W use time and date is the time and date of use of the reader/writer (or the time and date of execution of the transaction). A R/W transaction ID is identification information about the transaction that has occurred in the reader/writer. A type of use indicates the type of transaction such as payment, charging, stamp, coupon, or ticket. A payload is formed with a data structure corresponding to the type of use.

FIG. 12 illustrates the data structure of the payload of information about a transaction related to payment, as an example of the data structure of the payload corresponding to the type of use of the transaction. The payload in the case of payment includes data that is updated by transactions, such as a used amount, a balance, an increase/decrease in points, and remaining points.

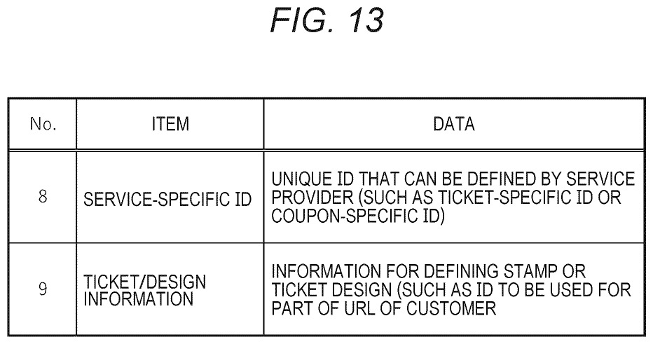

FIG. 13 illustrates the data structure of the payload of information about a transaction related to an action other than payment, as another example of the data structure of the payload corresponding to the type of use of the transaction. The payload in this case includes a service-specific ID and ticket/design information. The service-specific ID is a unique ID that can be defined by the service provider, and is a ticket ID, a coupon ID, or the like, for example. The ticket/design information is information for defining a stamp or ticket design, and includes an ID used for part of a uniform resource locator (URL) of a customer, for example. Note that the payload of the information about a transaction related to payment may also include a service-specific ID and ticket/design information.

### F. Effects

(1) A transaction is caused by a manual operation of holding the information processing apparatus 100 over the reader/writer 120. At that point of time, there is no need to start any SP application, and any notice is not sent to any SP application. In conventional cases, an SP application needs to actively access the secure element unit 114, to acquire the latest data (such as the used amount, the balance, the increase/decrease in points, and the remaining points) changed by a transaction. With the transaction information notification function according to the present disclosure, on the other hand, all the relevant SP applications can immediately sense that the data in the secure element unit 114 has changed due to a transaction. Specifically, such a function of notifying SP applications is achieved by installing the function illustrated in FIG. 6 into the service integration client in the middleware. Thus, with the notification function according to the present disclosure, the SP applications can grasp the information about a transaction without accessing the secure element unit 114, and promptly present the latest information such as the balance indicator changed by the transaction.

Also, with the transaction information notification function according to the present disclosure, the number of times the secure element unit 114 is accessed by SP applications is minimized. Accordingly, the application startup time is expected to be shortened, and the rate of occurrence of an access contention among a plurality of SP applications can be lowered. In a situation where simultaneous access to the secure element unit 114 by a plurality of SP applications is prohibited, an ability to reduce access contentions is particularly effective. Since the number of times the secure element unit 114 is accessed is minimized, a request to the service integration client and an inquiry to the service integration server for an SP application to hold an exclusive right to use the secure element unit 114 become unnecessary, and thus, the network load and the server load are also reduced.

With the transaction information notification function according to the present disclosure, when the data in the secure element unit 114 changes due to a transaction such as charging, a relevant SP application can immediately update information such as the balance, and constantly present the latest information through the screen of the information processing apparatus 100 or the like.

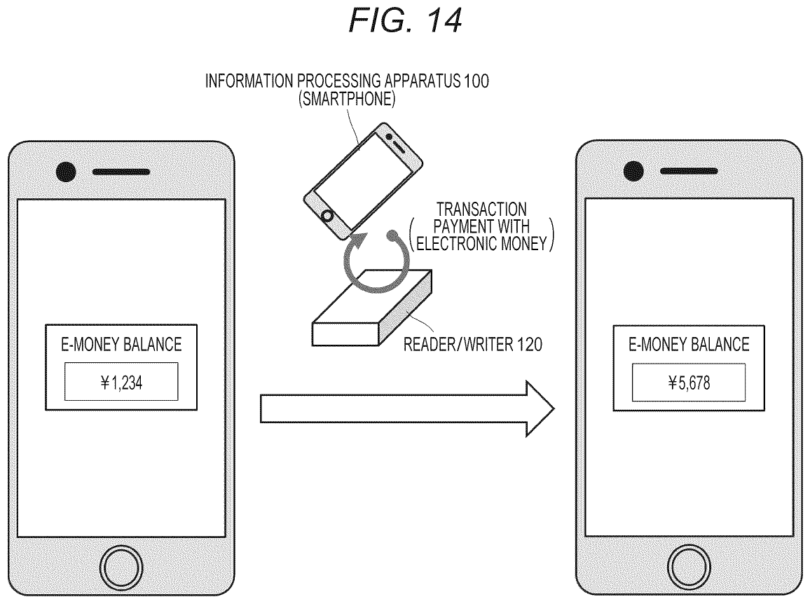

FIG. 14 illustrates an example in which the screen is updated in response to a change in the data in the secure element unit 114 due to the occurrence of a transaction. Specifically, FIG. 14 illustrates a state in which the balance of the electronic money being presented on the screen of a smartphone is promptly updated to the latest information, because of the occurrence of a transaction (payment, charging, or the like).

When the information processing apparatus 100 (a smartphone) is held over the reader/writer 120, and a transaction such as payment or charging occurs, the information in the secure element unit 114 changes. With the notification function according to the present disclosure, a notification target SP application is notified of the latest information in the secure element unit 114, after determination of the notification target SP application and verification of validity of the notification target SP application. As a result, as illustrated on the right side in FIG. 14, the notification target SP application can immediately update the balance of the electronic money on the screen from the amount (1,234 yen) before the transaction to the amount (5,678 yen) after the transaction, and present the updated balance. When the indicated amount is updated, a user operation such as starting the SP application, and the SP application's exclusive right to use the secure element unit 114 are unnecessary.

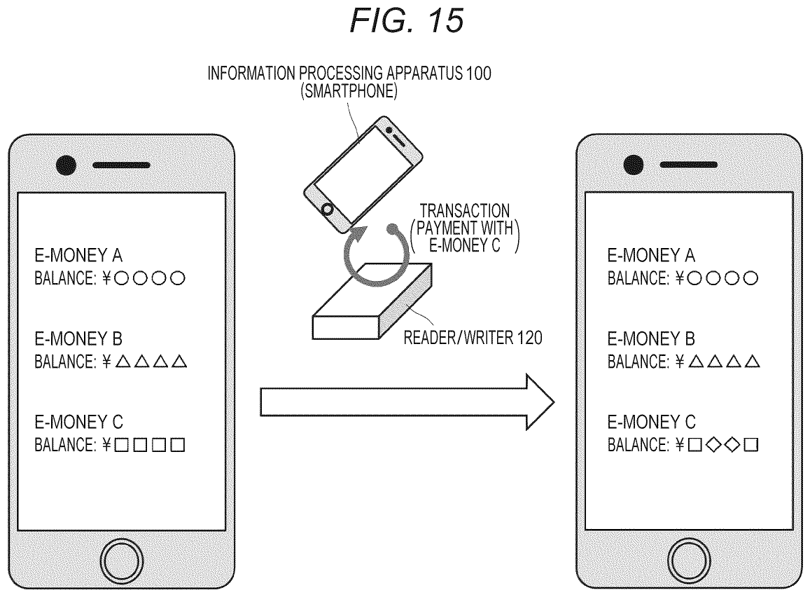

Further, FIG. 15 illustrates another example in which the screen is updated in response to a change in the data in the secure element unit 114 due to the occurrence of a transaction. Specifically, FIG. 15 illustrates a state in which part of the balance of electronic money changed due to the occurrence of a transaction (payment, charging, or the like) is promptly updated on an integrated balance display screen of a wallet application that can use a plurality of kinds of electronic money.

When the information processing apparatus 100 (a smartphone) is held over the reader/writer 120, and a transaction such as payment or charging with electronic money C occurs, the information about the electronic money C changes in the secure element unit 114. With the notification function according to the present disclosure, the notification target SP application is notified of the latest information about the electronic money C in the secure element unit 114, after the SP application related to services with the electronic money C is determined to be the notification target, and validity of the SP application is verified. As a result, as illustrated on the right side in FIG. 15, on the integrated balance display screen of the wallet application, the balance of the electronic money C can be promptly updated and presented. When the indicated amount is updated, a user operation such as starting the SP application corresponding to the electronic money C, and the SP application's exclusive right to use the secure element unit 114 are unnecessary. Note that the SP application that has received the notification can also realize a user experience (UX) in which a coupon is acquired and displayed on the basis of the use information about the electronic money C, or the user is prompted to start the SP application in the background of the screen update process.

Meanwhile, in a case where an SP application actively acquires information in the secure element unit 114 in a conventional manner, the SP application normally performs a use application procedure on the service integration client, and the service integration client makes an inquiry about validity (identity) confirmation of the SP application or an operation on the secure element permitted for the SP application. The SP application then exclusively holds the right to use the secure element unit 114. Therefore, when an SP application is started to present the latest data (such as the balance) in the secure element unit 114, the processing time, the network load, and the server load that accompany the exclusive right to use the secure element unit 114 are necessary.

(2) With the transaction information notification function according to the present disclosure, it is possible to notify a plurality of relevant SP applications of information such as the transaction processing target data. Specifically, such a function of simultaneously notifying a plurality of SP applications is achieved by installing the data analysis and SP determination function illustrated in FIG. 6 into the service integration client in the middleware. As a result of being able to notify a plurality of SP applications of transaction information, a plurality of SP applications using the same electronic money can update the information, for example.

It can also be said that the transaction information notification function according to the present disclosure can control SP applications that are notification destinations. Even when a transaction occurs between the secure element unit 114 and the reader/writer 120, only the SP applications that need the information that has changed as a result of the transaction can be determined to be notification targets, and the SP applications that should not be notified of the information are not notified of the information.

(3) With the transaction information notification function according to the present disclosure, it is possible to verify validity of an SP application determined to be a notification target, and not to pass transaction information on to any unauthorized application. For example, there are cases where an unauthorized SP application having an external appearance or a package name falsified to look like an authentic one is created. In the present disclosure, validity of an SP application is verified with verification information obtained by combining the package name of the SP application and the signature value of the SP application. Thus, it is possible to prevent leakage, unauthorized use, falsification, and the like of the information in the secure element unit 114, by eliminating unauthorized SP applications.

### INDUSTRIAL APPLICABILITY

The present disclosure has been described in detail with reference to a specific embodiment. However, it is obvious that those skilled in the art can make modifications and substitutions of the embodiment without departing from the scope of the present disclosure.

In the present specification, an embodiment in which the present disclosure is applied to a smartphone equipped with a secure element such as an IC chip that performs noncontact communication has been mainly described, but the subject matter of the present disclosure is not limited to this. The present disclosure can also be applied to various types of information processing apparatuses equipped with a device that performs transactions with an external device through wireless or wired communication other than noncontact communication, and a relevant application can be notified of information regarding the transaction performed between the device and the external device.

In short, the present disclosure has been described in an illustrative manner, and the contents disclosed in the present specification should not be interpreted in a limited manner. To determine the subject matter of the present disclosure, the claims should be taken into consideration.

Note that the present disclosure may also have the following configurations.

(1) An information processing apparatus in which a device that performs a transaction with an external device is mounted,
the information processing apparatus including:
a sensing unit that senses that a transaction has occurred between the device and the external device;
an acquisition unit that acquires data from the device, in response to the sensing unit sensing occurrence of the transaction;
a determination unit that analyzes the data acquired by the acquisition unit, and determines applications as notification targets;
a verification unit that verifies validity of the applications as the notification targets; and
a notification unit that notifies a relevant application whose validity has been confirmed among the notification targets, of the data acquired by the acquisition unit.

(2) The information processing apparatus according to (1), in which
the sensing unit senses occurrence of the transaction on the basis of transmission from an operating system.

(3) The information processing apparatus according to (1) or (2), in which
the acquisition unit acquires data from the device via an OMAPI.

(4) The information processing apparatus according to any one of (1) to (3), in which
the acquisition unit acquires processing target data of the transaction and data related to processing of the transaction.

(5) The information processing according to any one of (1) to (4), in which
the determination unit identifies a service ID related to the transaction on the basis of the data acquired by the acquisition unit, and determines an application as a notification target on the basis of the service ID.

(6) The information processing apparatus according to (5), in which
the determination unit analyzes data related to processing of the transaction, the data being acquired by the acquisition unit, and identifies the service ID related to the transaction.

(7) The information processing apparatus according to any one of (1) to (6), in which
the verification unit verifies validity of an application, on the basis of verification information about the application, the verification information being acquired from a server, and information about the application, the information being acquired from an operating system.

(8) The information processing apparatus according to (7), in which
the verification information includes a package name and a signature value of the application.

(9) The information processing apparatus according to any one of (1) to (8), in which
the notification unit notifies the relevant application of processing target data of the transaction.

(10) The information processing apparatus according to any one of (1) to (9), in which,
in a case where there is a plurality of the relevant applications, the notification unit performs notification at predetermined time intervals between the applications.

(11) The information processing apparatus according to any one of (1) to (10), in which
the notification unit performs notification to the relevant application, on the basis of information acquired from a server with respect to each application.

(12) The information processing apparatus according to (11), in which
the information acquired from the server with respect to each application includes at least one of a priority level of notification, a deadline for notification, or an action to be taken when the deadline for notification has passed.

(13) The information processing apparatus according to any one of (1) to (12), in which
the device performs the transaction with the external device through noncontact communication.

(13-1) The information processing apparatus according to (13), in which
the noncontact communication is communication for performing mutual authentication and encryption.

(14) The information processing apparatus according to any one of (1) to (13), in which
the transaction occurs without a start of an application installed in the information processing apparatus and without notice.

(15) An information processing method implemented in an apparatus in which a device that performs a transaction with an external device is mounted,
the information processing method including:
a sensing step of sensing that a transaction has occurred between the device and the external device;
an acquisition step of acquiring data from the device, in response to the sensing of occurrence of the transaction in the sensing step;
a determination step of analyzing the data acquired in the acquisition step, and determining applications as notification targets;
a verification step of verifying validity of the applications as the notification targets; and
a notification step of notifying a relevant application whose validity has been confirmed among the notification targets, of the data acquired in the acquisition step.

(16) A computer program written in a computer-readable format for an information processing apparatus in which a device that performs a transaction with an external device is mounted,
the computer program causing the information processing apparatus to function as:
a sensing unit that senses that a transaction has occurred between the device and the external device;
an acquisition unit that acquires data from the device, in response to the sensing unit sensing the occurrence of the transaction;
a determination unit that analyzes the data acquired by the acquisition unit, and determines applications as notification targets;
a verification unit that verifies validity of the applications as the notification targets; and
a notification unit that notifies a relevant application whose validity has been confirmed among the notification targets, of the data acquired by the acquisition unit.

(17) An information processing apparatus in which a device that performs a transaction with an external device is mounted, and an application that provides a service related to the transaction is installed,
the information processing apparatus including:
a notification unit that notifies the application of processing target data of the transaction; and
a presentation unit that presents information related to the processing target data received by the application.

(18) The information processing apparatus according to (17), further including
an access unit that accesses a secure element by cooperation between the application and a server.

(19) An information processing method implemented by an application in an apparatus in which a device that performs a transaction with an external device is mounted, and the application that provides a service related to the transaction is installed,
the information processing method including:
a receiving step of receiving processing target data of the transaction; and
a presentation step of presenting information related to the received processing target data.

(20) A computer program written in a computer-readable format for an information processing apparatus in which a device that performs a transaction with an external device is mounted, and an application that provides a service related to the transaction is installed,
the computer program causing the information processing apparatus to function as:
a receiving unit that receives processing target data of the transaction; and
a presentation unit that presents information related to the received processing target data.

### REFERENCE SIGNS LIST

100 Information processing apparatus
101 CPU
102 ROM
103 RAM
104 Host bus
105 Bridge
106 Expansion bus
107 Interface unit
108 Input unit
109 Output unit
110 Storage unit
111 Drive
112 Removable recording medium
113 Communication unit
114 Secure element unit
120 Reader/writer
201 Antenna unit
202 Analog unit
203 Digital unit
204 Memory
205 External interface (external IF)

1. An information processing apparatus in which a device that performs a transaction with an external device is mounted,
the information processing apparatus comprising:
a sensing unit that senses that a transaction has occurred between the device and the external device;
an acquisition unit that acquires data from the device, in response to the sensing unit sensing occurrence of the transaction;
a determination unit that analyzes the data acquired by the acquisition unit, and determines applications as notification targets;
a verification unit that verifies validity of the applications as the notification targets; and
a notification unit that notifies a relevant application whose validity has been confirmed among the notification targets, of the data acquired by the acquisition unit.

2. The information processing apparatus according to claim 1, wherein
the sensing unit senses occurrence of the transaction on a basis of transmission from an operating system.

3. The information processing apparatus according to claim 1, wherein
the acquisition unit acquires data from the device via an open mobile API (OMAPI).

4. The information processing apparatus according to claim 1, wherein
the acquisition unit acquires processing target data of the transaction and data related to processing of the transaction.

5. The information processing according to claim 1, wherein
the determination unit identifies a service ID related to the transaction on a basis of the data acquired by the acquisition unit, and determines an application as a notification target on a basis of the service ID.

6. The information processing apparatus according to claim 5, wherein
the determination unit analyzes data related to processing of the transaction, the data being acquired by the acquisition unit, and identifies the service ID related to the transaction.

7. The information processing apparatus according to claim 1, wherein
the verification unit verifies validity of an application, on a basis of verification information about the application, the verification information being acquired from a server, and information about the application, the information being acquired from an operating system.

8. The information processing apparatus according to claim 7, wherein
the verification information includes a package name and a signature value of the application.

9. The information processing apparatus according to claim 1, wherein
the notification unit notifies the relevant application of processing target data of the transaction.

10. The information processing apparatus according to claim 1, wherein,
in a case where there is a plurality of the relevant applications, the notification unit performs notification at predetermined time intervals between the applications.

11. The information processing apparatus according to claim 1, wherein
the notification unit performs notification to the relevant application, on a basis of information acquired from a server with respect to each application.

12. The information processing apparatus according to claim 11, wherein
the information acquired from the server with respect to each application includes at least one of a priority level of notification, a deadline for notification, or an action to be taken when the deadline for notification has passed.

13. The information processing apparatus according to claim 1, wherein
the device performs the transaction with the external device through noncontact communication.

14. The information processing apparatus according to claim 1, wherein
the transaction occurs without a start of an application installed in the information processing apparatus and without notice.

15. An information processing method implemented in an apparatus in which a device that performs a transaction with an external device is mounted,
the information processing method comprising:
a sensing step of sensing that a transaction has occurred between the device and the external device;
an acquisition step of acquiring data from the device, in response to the sensing of occurrence of the transaction in the sensing step;
a determination step of analyzing the data acquired in the acquisition step, and determining applications as notification targets;
a verification step of verifying validity of the applications as the notification targets; and
a notification step of notifying a relevant application whose validity has been confirmed among the notification targets, of the data acquired in the acquisition step.

16. A computer program written in a computer-readable format for an information processing apparatus in which a device that performs a transaction with an external device is mounted,
the computer program causing the information processing apparatus to function as:
a sensing unit that senses that a transaction has occurred between the device and the external device;
an acquisition unit that acquires data from the device, in response to the sensing unit sensing occurrence of the transaction;
a determination unit that analyzes the data acquired by the acquisition unit, and determines applications as notification targets;
a verification unit that verifies validity of the applications as the notification targets; and
a notification unit that notifies a relevant application whose validity has been confirmed among the notification targets, of the data acquired by the acquisition unit.

17. An information processing apparatus in which a device that performs a transaction with an external device is mounted, and an application that provides a service related to the transaction is installed,
the information processing apparatus comprising:
a notification unit that notifies the application of processing target data of the transaction; and
a presentation unit that presents information related to the processing target data received by the application.

18. The information processing apparatus according to claim 17, further comprising
an access unit that accesses a secure element by cooperation between the application and a server.

19. An information processing method implemented by an application in an apparatus in which a device that performs a transaction with an external device is mounted, and the application that provides a service related to the transaction is installed,
the information processing method comprising:
a receiving step of receiving processing target data of the transaction; and
a presentation step of presenting information related to the received processing target data.

20. A computer program written in a computer-readable format for an information processing apparatus in which a device that performs a transaction with an external device is mounted, and an application that provides a service related to the transaction is installed,
the computer program causing the information processing apparatus to function as:
a receiving unit that receives processing target data of the transaction; and
a presentation unit that presents information related to the received processing target data.
